(19) United States
(12) Patent Application Publication
(10) Pub. No.: US 2006/0244504 A1
(43) Pub. Date: Nov. 2, 2006

(54) Clock processing circuit

(76) Inventor: Kazuyoshi Kawabe, Yokohama (JP)

Correspondence Address: Pamela R. Crocker;Patent Legal Staff, Eastman Kodak Company, 343 State Street, Rochester, NY, 14650-2201, US

(21) Appl. No.: 11/401,991

(22) Filed: Apr. 11, 2006

(30) Foreign Application Priority Data
Apr. 22, 2005 (JP) 2005-125241

(51) Int. Cl. G06F 1/04

(52) U.S. Cl. 327/291

(57) ABSTRACT

A clock processing circuit wherein input clocks are converted into stabilized output clocks, includes a first level shifter and a second level shifter; first and second buffer circuits for producing stabilized output clocks; a first output conductive path from the first level shifter and a second output conductive path from the second level shifter provided to the first buffer and a second buffer over the first and second conductive paths respectively; and the first buffer being disposed adjacent to the first level shifter and the second buffer being disposed adjacent to the second level shifter so that the delay amount of clocks on two conductive paths is reduced and a difference in delay amounts between these clocks is reduced or suppressed.

### FIELD OF THE INVENTION

The present invention relates to a clock processing circuit for stabilizing a pair of input clocks having complementary phases and outputting the stabilized clocks.

### BACKGROUND OF THE INVENTION

Small size displays such as liquid crystal displays (LCDs) and organic EL displays are used in portable information terminals such as mobile phones, digital cameras, and the like, and there is a demand for further reduction in size and weight and an increase in resolution for such displays.

Small size displays employing a thin film transistor (TFT) in which low temperature poly-silicon is used as an active layer are advantageous in that they can be configured to form a driver circuit and other various circuits on a glass substrate. Accordingly, in such displays using a TFT, despite their small size, various functions can be installed, thereby increasing their value as a product.

Here, the various circuits formed on the glass substrate are driven by a control signal which is input from an external IC (Integrated Circuit) or the like. Of such control signals, a clock signal is significant. Generally, because the operation of a TFT is stabilized at a relatively high voltage (5V to 10V), a voltage (approximately 3V to 5V) which is input from the external IC is level-shifted.

FIG. 2 shows a prior art two-phase level shift buffer circuit. Level-shift circuits are shown in US Published Patent Application No. 2005/0057553 A1. A pair of input clocks CLK1 in and CLK2 in having complementary phases, which are input from the external IC, are supplied to a level shifter 5 having two inputs and two outputs. The level shifter 5 includes two paths each formed by a p-channel TFT and an n-channel TFT connected serially between a positive power source VDD and a negative power source VSS. A connecting point (Lout2) between two TFTs in the first path is connected to a gate of the n-channel TFT in the second path, and a connecting point (Lout1) between two TFTs in the second path is connected to a gate of the n-channel TFT in the first path. By inputting the input clocks CLK1in and CLK2in to gates (Lin1 and Lin2) of a pair of p-channel TFTs, output clocks whose amplitude has been level-shifted to VDD−VSS are obtained at the points Lout2 and Lout1.

The level-shifted clock obtained at Lout1 is input to Bin1 of a first buffer 6, and the level-shifted clock obtained at Lout2 is input to Bin2 of a second buffer 7. These first and second buffers 6 and 7 are formed by a plurality of inverters connected in parallel, and each inverter is formed by a p-channel TFT and an n-channel TFT serially connected between the positive power source VDD and the negative power source VSS. Specifically, a common clock which has been level-shifted is input to a gate of the p-channel and the n-channel TFTs forming each inverter, and a common output clock which has been buffered is obtained at a connecting point between the p-channel TFT and the n-channel TFT.

Here, the output Lout1 of the level shifter 5 is connected to the input Bin1 of the first buffer 6, and the output Lout2 of the level shifter 5 bypasses the first buffer 6 and is connected to the input Bin2 of the second buffer 7.

The above-described circuit shown in FIG. 2 can be used as a clock buffer circuit of a display, in which when clock pulses having an amplitude of Vin and having different polarities as shown in FIG. 3 are input to the first input CLK1in and the second input CLK2in, respectively, output clock pulses having an amplitude Vout (=VDD−VSS) and having different polarities, which have been level-shifted, are obtained at a first output CLKout and a second output CLK2out, respectively.

In general, a clock buffer circuit supplies a clock to a great number of circuits and therefore requires high driving force. Accordingly, each of the buffers 6 and 7 is formed by a plurality of inverters connected in parallel.

Although the clock buffer circuit having the structure as shown in FIG. 2, however, there is a difference between a line extending from the output Lout1 of the level shifter 5 to the input Bin1 of the first buffer 6 and a line extending from the output Lout2 of the level shifter 5 to the input Bin2 of the second buffer 7. More specifically, the line extending from Lout2 to Bin2 is longer than the line extending from Lout1 to Bin1 by a distance corresponding to a distance in which the former line bypasses the first buffer 6. As the length of a line increases, the line load is also increased accordingly. Consequently, a delay is caused between the buffer inputs Bin1 and Bin2, which further results in a delay Δt between the outputs CLK1out and CLK2out as shown in FIG. 3.

Because a clock signal output from the clock buffer is supplied to a great number of circuits, such a delay is undesirable and causes erroneous operation, especially in an application which requires a high frequency.

### SUMMARY OF THE INVENTION

In accordance with one aspect of the present invention, there is provided a clock processing circuit for stabilizing a pair of input clocks having complementary phases and outputting a pair of stabilized clocks, the clock processing circuit comprising a first converting circuit for converting the pair of input clocks into a pair of clocks having an amplitude in accordance with a power source voltage and outputting a first converted clock having a first phase, the first converted clock being one of the pair of converted clocks; a second converting circuit for converting the pair of input clocks into a pair of clocks having an amplitude in accordance with a power source voltage and outputting a second converted clock having a second phase opposite to the first phase, the second converted clock being one of the pair of converted clocks; a first buffer circuit disposed adjacent to the first converting circuit, for outputting a first stabilized clock which is stabilized by buffering the first converted clock; and a second buffer circuit disposed adjacent to the second converting circuit, for outputting a second stabilized clock which is stabilized by buffering the second converted clock, whereby first and second stabilized clocks having complementary phases are output.

Preferably, each of the first buffer circuit and the second buffer circuit is formed by a plurality of inverter circuits connected in parallel to each other, and each inverter includes a p-channel transistor and an n-channel transistor which are connected in series between a positive power source and a negative power source, and each inverter receives an input signal at control terminals of the transistors and obtains an output signal whose phase has been inverted at a connecting terminal of the transistors.

Preferably, each of the first converting circuit, the second converting circuit, the first buffer circuit, and the second buffer circuit is formed using a thin film transistor as an active element.

Preferably, each of the first converting circuit and the second converting circuit level-shifts an input clock and outputs a level-shifted clock.

Preferably, the first converting circuit and the second converting circuit have the same structure.

Preferably, the first converting circuit and the second converting circuit have common input paths for a pair of input clocks.

As described above, according to the present invention, clocks output from the first and second converting circuits are input to the first and second buffer circuits which are disposed adjacent to the respective first and second converting circuits, respectively. With this structure, it is possible to achieve the input path from the first converting circuit to the first buffer circuit and the input path from the second converting circuit to the second buffer circuit which are both very short and have substantially the same distance to thereby reduce a delay caused in these input paths, whereby a stabilized output clock can be obtained.

In particular, each of the first and second converting circuits can provide a pair of converted clocks. While in the related art structure, a single converting circuit is provided and outputs a pair of converted clock, according to the present invention, two converting circuits are provided to thereby prevent generation of a timing error between a pair of output clocks.

While each of the first and second converting circuits may have one input and one output, in this case, effects of characteristic variations between the two converting circuits is increased, and a pair of the output clocks are likely to be unbalanced especially when the signal level of the input signals is low. According to the present invention, each converting circuit is configured to have two inputs and two outputs, so that a stabilized operation can be achieved even when the signal level of an input signal is low.

In particular, by forming the first and second converting circuits as level shifters, a clock can be boosted, so that a clock having a desired voltage can be achieved.

### BRIEF DESCRIPTION OF THE DRAWINGS

A preferred embodiment of the present invention will be described in detail based on the following figures, wherein:

FIG. 1 is a diagram showing a circuit structure according to an embodiment of the present invention;

FIG. 2 is a diagram showing a prior art circuit structure; and

FIG. 3 shows input and output pulse waveforms.

### DETAILED DESCRIPTION OF PREFERRED EMBODIMENT

A preferred embodiment of the present invention will be described in detail with reference to the accompanying drawings.

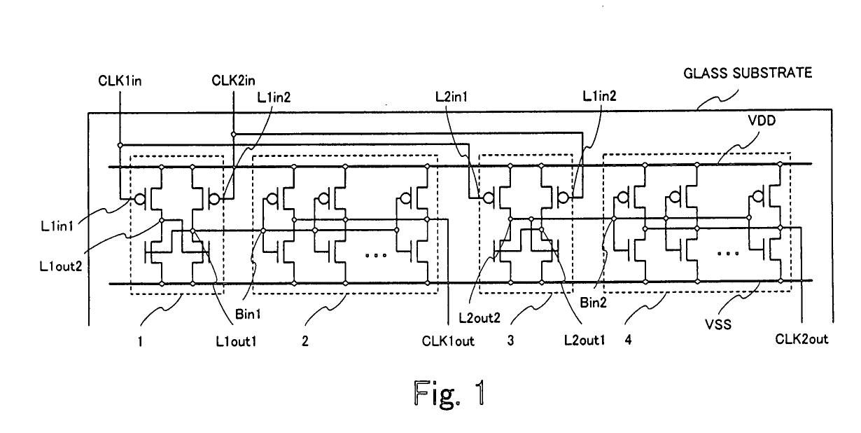

FIG. 1 shows a two-phase level shift buffer circuit which includes a first level shifter 1, a second level shifter 3, a first buffer 2, and a second buffer 4.

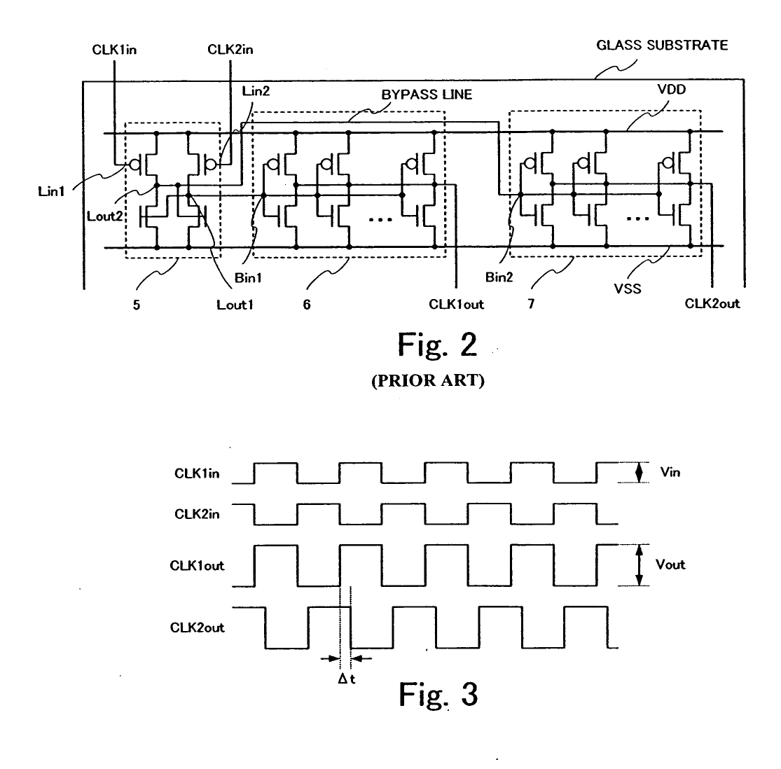

As in the related art example shown in FIG. 2, a pair of input clocks CLK1in and CLK2in having complementary phases as shown in FIG. 3 are supplied from an external IC to the two-phase level shift buffer circuit, where the input clocks are level-shifted as shown in FIG. 3 and converted into stabilized output clocks CLK1out and CLK2out, which are then output.

More specifically, the input clocks CLK1in and CLK2in are input to the first level shifter 1 having two inputs. As with the related art example shown in FIG. 2, the first level shifter 1 includes two paths each formed by a p-channel TFT and an n-channel TFT which are connected in series between a positive power source VDD (for example, 5 to 10V) and a negative power source VSS (for example, 0V). A connecting point (L1out2) between two TFTs in the first path is connected to a gate of the n-channel TFT in the second path, and a connecting point (L1out1) between two TFTs in the second path is connected to a gate of the n-channel TFT in the first path.

When the input clocks CLK1in and CLK2in are input to gates (L1in1 and L1in2) of the pair of p-channel TFTs to turn one p-channel TFT on, the n-channel TFT connected to the other p-channel TFT is turned on and the n-channel TFT connected to the p-channel TFT which is turned on is turned off. Consequently, clocks whose amplitudes are level-shifted to VDD−VSS can be obtained at the points L1out1 and L1out2 while preventing a through current. Here, in the first level shifter 1, a drain of the p-channel TFT whose gate receives the input clock CLK2 in corresponds to the point L1out1, of the clocks which are obtained at the points L1out1 and L1out2, only the clock having a phase opposite to that of the input clock CKL1 in is output from L1out1.

The second level shifter 3, which has a structure similar to that of the first level shifter 1, outputs, of the clocks which have been level-shifted and are obtained at the points L2out2 and L2out1, only the clock having a phase opposite to that of the input clock CLK2 in from the point L2out2.

Here, the first and second level shifters 1 and 3 need not necessarily have the structure shown in FIG. 1, and may have any structure as long as a pair of input clocks can be converted into a pair of level-shifted clocks. However, in order to maintain the same characteristics of the level-shifted clocks, it is preferable that the first and second level shifters 1 and 3 have the same structure.

The level-shifted clock output from L1out1 of the first level shifter 1 is input to Bin1 of the first buffer 2. On the other hand, the level-shifted clock output form L2out2 of the second level shifter 3 is input to Bin2 of the second buffer 4.

As in the related art example shown in FIG. 2, the first and second buffers 2 and 4 are also formed by a plurality of inverters connected in parallel, each being composed of an p-channel TFT and an n-channel TFT connected in series between the positive power source VDD and the negative power source VSS. Specifically, a common clock which has been level-shifted is input to the gates of the p-channel TFT and the n-channel TFT forming each inverter and a common clock which has been buffered is output from the connecting point between the p-channel TFT and the n-channel TFT of each inverter.

Accordingly, an output clock CLKout1 having the same phase as that of the input clock CLKin1, which has been level-shifted and stabilized, is output from the connecting point between the p-channel TFT and the n-channel TFT of the first buffer 2. Also, an output clock CLKout2 having the same phase as that of the input clock CLKin2, which has been level-shifted and stabilized is output from the connecting point between the p-channel TFT and the n-channel TFT of the second buffer 4.

Here, the first and second buffers 2 and 4 may be formed by similar inverters which are serially connected in several stages.

According to the present embodiment, as shown in FIG. 1, the first buffer 2 is disposed directly adjacent to the first level shifter 1 and the second buffer 4 is disposed directly adjacent to the second level shifter 3. With such an arrangement, the p-channel TFTs and the n-channel TFTs can be disposed in alignment and the positive power source VDD line and the negative power source VSS line can be commonly used, whereby the circuit region of the display can be reduced. Thus, the circuit of the present invention is more suitable for a small size apparatus.

Further, the output L1out1 from the level shifter 1 is connected to the input Bin1 of the first buffer 2 which is disposed adjacent to the level shifter 1, and the output L2out2 from the level shifter 2 is connected to the input Bin2 of the second buffer 4 which is disposed adjacent to the level shifter 3.

Consequently, as both the distance from the output L1out1 of the first level shifter 1 to the input Bin1 of the first buffer 2 and the distance from the output L2out2 of the second level shifter 3 to the input Bin2 of the second buffer 4 can be reduced, phases of the output clocks CLK1out and CLK2out can be made substantially the same. In other words, it is possible to effectively reduce the possibility of generation of a delay Δt shown in FIG. 3.

Further, if a greater number of inverters are connected in parallel in order to increase a drive force of the buffers, while in the related art example, the delay line is extended to thereby further increase the delay, according to the present embodiment, such an increase in the number of inverters will have substantially no effects on the delay. Consequently, even when a great number of circuits are formed on a substrate or when the load of the lines is increased by increasing the substrate size, a high speed operation which is further stabilized can be achieved by using the level shift clock buffer of the present embodiment.

Here, each of the first and second level shifters can provide a pair of level-shifted clocks. Accordingly, in ordinary configurations, only a single level shifter is provided to output a pair of converted clocks which are obtained, as in the related art example shown in FIG. 2. According to the present embodiment, however, two level shifters are provided in such a manner that each level shifter is disposed adjacent to the corresponding buffer, whereby generation of timing error in the pair of output clocks is prevented.

Further, each of the first and second level shifters may have one input and one output. In this case, however, effects of characteristics variation between the two level shifters is increased, and a pair of the output clocks are likely to be unbalanced especially when the signal level of the input clock is low. According to the present invention, each level shifter is configured to have two inputs and two outputs so as to achieve a stabilized operation even when the level of the input clock is low.

As described above, according to the present embodiment, it is possible to level-shift and buffer a pair of two-phase pulse signals having opposite polarities, while reducing a delay with respect to each other.

The above-described circuit of the present embodiment is suitable for a horizontal driver in LCDs and organic EL displays, in which a sufficient on/off operation of the switch in accordance with a high speed clock should be performed, thereby requiring a clock having a sufficient drive force.

Further, it is also preferable to use the level shift buffer circuit shown in FIG. 1 as a clock buffer which simply increases a drive force of a clock without shifting the voltage.

Although the preferred embodiment of the present invention has been described using specific terms, such description is for illustrative purposes only, and it is to be understood that changes and variations may be made without departing from the spirit or scope of the appended claims.

### PARTS LIST

1 first level shifter
2 first buffer
3 second level shifter
4 second buffer
5 level shifter
6 first buffer
7 second buffer
Bin1 buffer input
Bin2 buffer input
CLK2in input clock
CLK2out second output
CLKin1 input clock
CLKin2 input clock
CLK1in input clock
CLKout first output
CLKout1 output clock
CLKout2 output clock
IC Integrated Circuit
L1out1 connecting point
L2out2 connecting point
Lin1 gate
Lin2 gate
L1in1 gate
L1in2 gate
L1out2 connecting point
Lout1 connecting point
Lout2 connecting point
VDD positive power source
VSS negative power source

1. A clock processing circuit wherein input clocks are converted into stabilized output clocks, comprising:
(a) a first level shifter and a second level shifter;
(b) first and second buffer circuits for producing stabilized output clocks;
(c) a first output conductive path from the first level shifter and a second output conductive path from the second level shifter provided to the first buffer and a second buffer over the first and second conductive paths respectively; and
(d) the first buffer being disposed adjacent to the first level shifter and the second buffer being disposed adjacent to the second level shifter so that the delay amount of clocks on two conductive paths is reduced and a difference in delay amounts between these clocks is reduced or suppressed.

2. A clock processing circuit for stabilizing a pair of input clocks having complementary phases and outputting a pair of stabilized clocks, the clock processing circuit coupled to a power source voltage, comprising:
a first converting circuit for converting the pair of input clocks into a pair of clocks having an amplitude in accordance with the power source voltage and outputting a first converted clock having a first phase, the first converted clock being one of the pair of converted clocks;
a second converting circuit for converting the pair of input clocks into a pair of clocks having an amplitude in accordance with the power source voltage and outputting a second converted clock having a second phase opposite to the first phase, the second converted clock being one of the pair of converted clocks;
a first buffer circuit disposed adjacent to the first converting circuit and responsive to the first converted clock for outputting a first stabilized clock which is stabilized by buffering the first converted clock; and
a second buffer circuit disposed adjacent to the second converting circuit and responsive to the second converted clock for outputting a second stabilized clock which is stabilized by buffering the second converted clock;
a first connecting path for conducting the first converted clock to the first buffer circuit and a second connecting path for conducting the second converted clock to the second buffer circuit with the length of the first and second conducting paths being selected to be substantially the same;
whereby first and second stabilized clocks having complementary phases are produced.

3. A clock processing circuit according to claim 2, wherein:
each of the first buffer circuit and the second buffer circuit is formed by a plurality of inverter circuits connected in parallel to each other, each inverter including a p-channel transistor and an n-channel transistor which are connected in series between a positive power source and a negative power source and each inverter receiving an input signal at control terminals of the transistors and obtaining an output signal whose phase has been inverted at a connecting terminal of the transistors.

4. A clock processing circuit according to claim 2 wherein:
each of the first converting circuit, the second converting circuit, the first buffer circuit, and the second buffer circuit is formed using a thin film transistor as an active element.

5. A clock processing circuit according to claim 2 wherein:
each of the first converting circuit and the second converting circuit level-shifts an input clock and outputs a level-shifted clock.

6. A clock processing circuit according to claim 2 wherein:
the first converting circuit and the second converting circuit have the same structure.

7. A clock processing circuit according to claim 2 wherein:
the first converting circuit and the second converting circuit have common input paths for a pair of input clocks.
